(19) United States
(12) Patent Application Publication
(10) Pub. No.: US 2020/0387821 A1
(43) Pub. Date: Dec. 10, 2020

(54) AUTHENTICATION BASED ON A CHANGE IN A STATE OF A QUBIT

(71) Applicant: Red Hat, Inc., Raleigh, NC (US)

(72) Inventors: Leigh Griffin, Waterford City (IE); Stephen Coady, Waterford City (IE)

(21) Appl. No.: 16/431,363

(22) Filed: Jun. 4, 2019

(51) Int. Cl. G06N 10/00; G06F 15/16

(52) U.S. Cl. CPC G06N 10/00; G06F 15/16

(57) ABSTRACT

Authentication based on change of a state of a qubit is disclosed. A classical computing system receives a request to access a managed resource by a computing device that is associated with a user. The classical computing system accesses an access policy that dictates one or more preconditions for accessing the managed resource, the access policy identifying a qubit in a quantum computing system and a change in a state of the qubit as a precondition to granting access to the managed resource. The classical computing system determines that the change in the state of the qubit has occurred and, in response to determining that the change in the state of the qubit has occurred, grants, to the computing device, access to the managed resource.

### BACKGROUND

Quantum computing systems perform computations utilizing quantum-mechanical phenomena, such as superposition and entanglement. Unlike classical computing systems that process data encoded in binary bits, each of which is always in one of two definite states (“0” or “1”), quantum computing systems process data in units of quantum bits (qubits) that can be in superpositions of states. “Superposition” means that each qubit can represent both a “1” and a “0” at the same time. The qubits in a superposition can be correlated with each other (referred to as “entanglement”). That is, the state of a given qubit (whether it is a “1” or a “0”) can depend on the state of another qubit. A quantum computing system with N qubits can be in a superposition of up to 2^{N} states simultaneously. Compared to the classical computing systems that can only be in one of these 2^{N} states at a particular time, quantum computing systems have higher computing power and may solve difficult problems that are intractable using the classical computing systems.

### SUMMARY

The examples disclosed herein implement authentication based on a change in a state of a qubit.

In one example a method is provided. The method includes receiving, by a classical computing system, a request to access a managed resource by a computing device that is associated with a user. The method further includes accessing an access policy that dictates one or more preconditions for accessing the managed resource, the access policy identifying a qubit in a quantum computing system and a change in a state of the qubit as a precondition to granting access to the managed resource. The method further includes determining, by the classical computing system, that the change in the state of the qubit has occurred and, in response to determining that the change in the state of the qubit has occurred, granting, to the computing device, access to the managed resource.

In another example a classical computing system is provided. The classical computing system includes a memory and a processor device coupled to the memory. The processor device is to receive a request to access a managed resource by a computing device that is associated with a user. The processor device is further to access an access policy that dictates one or more preconditions for accessing the managed resource, the access policy identifying a qubit in a quantum computing system and a change in a state of the qubit as a precondition to granting access to the managed resource. The processor device is further to determine that the change in the state of the qubit has occurred and, in response to determining that the change in the state of the qubit has occurred, grant, to the computing device, access to the managed resource.

In another example a computer program product is provided. The computer program product is stored on a non-transitory computer-readable storage medium and includes instructions to cause a processor device to receive a request to access a managed resource by a computing device that is associated with a user. The instructions further cause the processor device to access an access policy that dictates one or more preconditions for accessing the managed resource, the access policy identifying a qubit in a quantum computing system and a change in a state of the qubit as a precondition to granting access to the managed resource. The instructions further cause the processor device to determine that the change in the state of the qubit has occurred and, in response to determining that the change in the state of the qubit has occurred, grant, to the computing device, access to the managed resource.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which examples may be practiced;

FIG. 2 is a flowchart of a method for authentication based on change of a state of a qubit according to one example;

FIG. 3 is a block diagram that illustrates a detailed implementation of the role-based access system illustrated in FIG. 1 according to one example;

FIG. 4 is a simplified block diagram of the environment illustrated in FIG. 1 according to another example; and

FIG. 5 is a block diagram of a classical computing system according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Quantum computing systems perform computations utilizing quantum-mechanical phenomena, such as superposition and entanglement. Unlike classical computing systems that process data encoded in binary bits, each of which is always in one of two definite states (“0” or “1”), quantum computing systems process data in units of quantum bits (qubits) that can be in superpositions of states. “Superposition” means that each qubit can represent both a “1” and a “0” at the same time. The qubits in a superposition can be correlated with each other (referred to as “entanglement”). That is, the state of a given qubit (whether it is a “1” or a “0”) can depend on the state of another qubit. A quantum computing system with N qubits can be in a superposition of up to 2^{N} states simultaneously. Compared to the classical computing systems that can only be in one of these 2^{N} states at a particular time, quantum computing systems have higher computing power and may solve difficult problems that are intractable using the classical computing systems.

As quantum computing becomes more common, quantum computers may play a role in service management within quantum computing systems or within classical computing systems. For example, prior to allowing a user to access a resource, an authentication mechanism may require that a state of a qubit be changed in a desired manner as verification that the user has proper rights to access the resource. Such a quantum authentication mechanism may be used by itself, or in conjunction with other authentication mechanisms, to implement a multi-factor authentication mechanism for either quantum-based resources and/or classical-based resources.

The examples disclosed herein implement authentication based on a change in a state of a qubit. An access control system may require that a user be properly authenticated before being granted access to a managed resource, such as access to a particular data file. The access control system may require a particular change in a state of a qubit as a precondition to granting access to the managed resource. In one example, a classical computing system receives a request to access a managed resource by a computing device associated with a user. An access policy that dictates one or more preconditions for accessing the managed resource is accessed. The access policy identifies a qubit in a quantum computing system and a change in a state of the qubit as a precondition to granting access to the managed resource. The classical computing system determines that the change in the state of the qubit has occurred and, in response to determining that the change in the state of the qubit has occurred, access to the managed resource is granted.

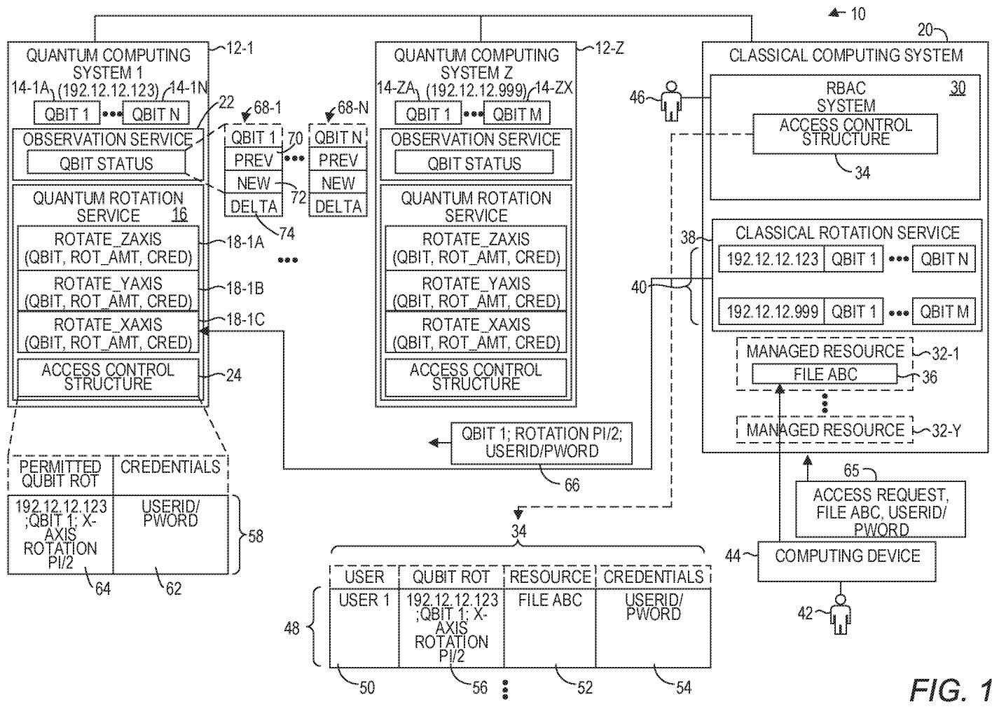

FIG. 1 is a block diagram of an environment 10 in which examples may be practiced. The environment 10 includes one or more quantum computing systems 12-1-12-Z (generally, quantum computing systems 12), each of which operates in a quantum environment. The phrase “quantum environment” as used herein refers to computing systems that perform computations utilizing quantum-mechanical phenomena, such as superposition and entanglement. Such computing systems often operate under certain environmental conditions, such as at or near 0° Kelvin. The phrase “classical environment” as used herein refers to a conventional computing system that operates using binary digits that have a value of either 1 or 0.

The quantum computing system 12-1 comprises a plurality of qubits 14-1A-14-1N. Generally, a state of a qubit may be represented by a Bloch sphere that contains an X-axis, a Y-axis, and a Z-axis. A quantum rotation of a qubit about a designated axis can be implemented via one or more programming instructions, and a change in state of the qubit due to the rotation may be observed. In particular, rotation actions may be invoked on a qubit programmatically via quantum assembly language (QASM) instructions, or via other suitable quantum computing programming languages.

In one example, predefined qubit rotations may be stored in one or more QASM instruction files. A particular QASM instruction file may then be invoked to cause a particular amount of rotation of a qubit, such as a designated fraction of Pi, about a particular axis.

The quantum computing system 12-1 includes a quantum rotation service 16 that includes a plurality of invocable functions 18-1A-18-1C that may be called or otherwise invoked by either a task executing on the quantum computing system 12-1, by an external task executing on the quantum computing system 12-Z, or by an external task executing on a classical computing system 20. The invocable function 18-1A is configured to rotate a qubit 14-1A-14-1N a designated amount about the Z-axis of the qubit 14-1A-14-1N. The invocable function 18-1A accepts as parameters a qubit identifier, a rotation amount, and authentication credentials to be used to validate that the entity invoking the invocable function 18-1A is authorized to do so.

The invocable function 18-1B is configured to rotate a qubit 14-1A-14-1N a designated amount about the Y-axis of the qubit 14-1A-14-1N. The invocable function 18-1B accepts as parameters a qubit identifier, a rotation amount, and authentication credentials to be used to validate that the entity invoking the invocable function 18-1B is authorized to do so.

The invocable function 18-1C is configured to rotate a qubit 14-1A-14-1N a designated amount about the X-axis of the qubit 14-1A-14-1N. The invocable function 18-1C accepts as parameters a qubit identifier, a rotation amount, and authentication credentials to be used to validate that the entity invoking the invocable function 18-1C is authorized to do so.

Example QASM code for various rotations of a qubit 14-1A-14-1N is as follows:

x q[1]; // X-axis on qubit 1 (e.g., qubit 14-1A)
y q[2]; // Y-axis on qubit 2
z q[1]; // Z-axis on qubit 1 (e.g., qubit 14-1A)
s gate // rotation gate for pi/2
s (dagger) s′ // rotation gate f or minus pi/2
t gate // rotation gate for pi/4
t (dagger) t′ // rotation gate for pi/4
s[1]// do a pi/2 rotation on qubit 1 (e.g., qubit 14-1A)
s′[1]// do a -pi/2 rotation on qubit 1 (e.g., qubit 14-1A)
T[1]// do a pi/4 rotation on qubit 1 (e.g., qubit 14-1A)

Function calls can be sequenced to perform a rotation on a particular axis. For example, the following instruction, z.s[1], causes a rotation about the Z-axis on qubit 1 (e.g., qubit 14-1A) by pi/2. The programmatic instructions result in a hardware rotation, such as via photonic lasers or the like, of the respective qubit.

The quantum computing system 12-1 includes an observation service 22 that periodically, or upon request or notification, observes and determines a current state of a qubit 14-1A-14-1N. The observation service 22 stores the current state of a qubit 14-1A-14-1N and compares the current state to a previously observed state of the qubit 14-1A-14-1N, to determine if a qubit 14-1A-14-1N has been rotated about an axis since a previously observed state, and if so, the amount of such rotation. As will be described in greater detail below, if the observation service 22 determines that a rotation about an axis of a qubit 14-1A-14-1N has occurred, the quantum computing system 12-1 may notify the classical computing system 20 of this.

The quantum computing system 12-1 also includes an access control structure 24 used to authenticate access to the qubits 14-1A-14-1N, as will be described in greater detail below.

The quantum computing system 12-Z is configured substantially similarly to the quantum computing system 12-1, and comprises a plurality of qubits 14-ZA-14-ZX.

The classical computing system 20 includes an authentication system, in this example a role-based access (RBAC) system 30, that controls access to various managed resources 32-1-32-Y (generally, managed resources 32) based at least in part on information maintained in an access control structure 34. The managed resources 32 can comprise any resource, such as a file 36, a database or a particular record in a database, an application programming interface, or any other digital entity that can be accessed. The classical computing system 20 also includes a classical rotation service 38 that maintains information 40 that identifies each of the quantum computing systems 12-1-12-Z, and identifies the qubits 14 maintained by the quantum computing systems 12-1-12-Z. The classical rotation service 38 is configured to invoke the quantum rotation service 16 of any of the quantum computing systems 12-1-12-Z to request that a particular qubit 14 be rotated a designated amount about a designated axis. While for purposes of illustration the classical rotation service 38 is separate from the RBAC system 30, in other examples, the classical rotation service 38 may be part of the RBAC system 30.

It is noted that because the RBAC system 30 and the classical rotation service 38 are components of the classical computing system 20, functionality implemented by the RBAC system 30 and the classical rotation service 38 may be attributed to the classical computing system 20 generally. Moreover, in examples where the RBAC system 30 and classical rotation service 38 comprise software instructions that program a processor device of the classical computing system 20 to carry out functionality discussed herein, functionality implemented by the RBAC system 30 and classical rotation service 38 may be attributed herein to such processor device.

An example of multifactor authentication using a combination of classical authentication and quantum authentication will now be discussed with reference to the managed resource 32-1, which in this example is the file 36. The phrase “managed resource” refers to a resource to which access is controlled based on designated rights. The designated rights may be in the form of preconditions. As an example, access to the file 36 may be based on one or more preconditions. Access to the file 36 is controlled by an authentication system, in the case the RBAC system 30, which may implement access rights alone or in conjunction with an operating system of the classical computing system 20. In some examples the RBAC system 30 may be part of the operating system of the classical computing system 20, and in others, the RBAC system 30 may exchange messages with the operating system of the classical computing system 20 to enforce access to a managed resource 32.

The RBAC system 30 uses the access control structure 34 to determine access rights to managed resources 32. The access control structure 34 may be maintained, for example, by one or more administrators or operators 46 of the environment 10 who designate access rights to managed resources 32-1-32-Y. In particular, the operator 46 may provide information to the RBAC system 30, via a user interface for example, to designate access rights to the file 36 by devices, such as a computing device 44, associated with a user 42. In this example, the operator 46 enters information that results in an access policy 48 in the access control structure 34 which controls access to the file 36 based in part on authentication credentials associated with the user 42. The information entered by the operator 46 includes a user identifier (ID) 50 that identifies the user 42, a managed resource ID 52 that identifies the file 36, and authentication credentials 54, in this example a user ID and password, of the user 42. Thus, one precondition to granting the computing device 44 access to the file 36 is that the computing device 44 (or the user 42) must provide the correct authentication credentials 54. In this example, the operator 46 also identifies a second precondition in the form of a qubit state change 56. The qubit state change 56 indicates that a pi/2 rotation about the X-axis of the qubit 14-1A of the quantum computing system 12-1 is also a precondition to granting the computing device 44 access to the file 36.

The operator 46, or another operator associated with the quantum computing system 12-1, similarly generates an access policy 58 in the access control structure 24 of the quantum computing system 12-1 that identifies a particular credential 62 of the user 42, and a permitted qubit state change 64. The credential 62 may be the same as the authentication credential 54, or may be different.

Assume that the computing device 44 attempts to access the file 36, represented in the form of a request 65. The request 65 may comprise, for example, a read request or write request by the computing device 44 of the file 36. The RBAC system 30 accesses the access policy 48 in the access control structure 34 and determines whether the user ID and password provided by the user 42 are correct based on the authentication credentials 54. The user ID and password may be provided by the computing device 44 in conjunction with attempting to access the file 36, as illustrated in the request 65, or may have been provided earlier, by the user 42, for example, during a logon sequence with the classical computing system 20. The RBAC system 30 confirms that the user ID and password in the request 65 or otherwise provided by the user 42 matches the authentication credentials 54. The RBAC system 30 determines, based on the qubit state change 56, that there is an additional precondition prior to granting the computing device 44 access to the file 36, in particular, that the qubit 14-1A of the quantum computing system 12-1 must have a pi/2 rotation about the X-axis. The RBAC system 30 sends a request to the classical rotation service 38 to implement the necessary qubit state change. The classical rotation service 38 accesses the information 40 to verify that the identified quantum computing system 12-1 is a quantum computing system that has been registered with the classical rotation service 38. The classical rotation service 38 sends a request 66 to the quantum computing system 12-1 that requests that the quantum computing system 12-1 change the state of the qubit 14-1A. In some examples, the request 66 may include the authentication credentials of the user 42. The mechanism for sending the request 66 may differ depending on the implementation of the quantum computing system 12-1. In this example, the classical rotation service 38 sends the request 66 by invoking the invocable function 18-1C (ROTATE_XAXIS) with the appropriate parameters, including the qubit 14 to be rotated, the amount of rotation, and the credentials of the user 42.

The quantum computing system 12-1, via the invocable function 18-1C, receives the request 66 that the quantum computing system 12-1 change the state of the qubit 14-1A. The quantum computing system 12-1 determines the user who is associated with the request 66, in this instance via the user ID and password provided in the request 66. In other examples, only the user ID may be provided in the request 66. The quantum computing system 12-1 authenticates that the user 42 has proper rights to request that the quantum computing system 12-1 change the state of the qubit 14-1A. In particular, the quantum computing system 12-1 accesses the access policy 58 and determines that the user ID and password contained in the request 66 match the credential 62. The quantum computing system 12-1 may also verify that the requested qubit state change in the request 66 matches the permitted qubit state change 64. The request 66 may be placed in a qubit state change queue (not illustrated) to ensure that multiple different changes to the states of the same qubit 14-1A-14-1N are attempted simultaneously.

In some examples, the quantum computing system 12-1 may obtain authentication credentials directly from the user 42. For example, after receipt of the request 66, the quantum computing system 12-1 may send the user 42 an SMS message requesting that the user 42 provide an appropriate password.

The quantum computing system 12-1 then causes the change in state of the qubit 14-1A. In particular, the invocable function 18-1C contains programming instructions that causes the qubit 14-1A to rotate pi/2 about the X-axis. The observation service 22 maintains state information 68-1-68-N about each qubit 14-1A-14-1N. The state information 68-1 includes a previous qubit state 70 that identifies a state of the qubit 14-1A at one point in time, a new qubit state 72 that identifies the state of the qubit 14-1A at a subsequent point in time, and a delta qubit state 74. The observation service 22 periodically, intermittently, or upon request, via for example a quantum application programming interface, observes the state of one or more of the qubits 14-1A-14-1N to determine whether a state of one or more of the qubits 14-1A-14-1N has changed since a previous observation. In some examples, the invocable functions 18-1A-18-1C may request that the observation service 22 observe the state of a particular qubit 14-1A-14-1N or all of the qubits 14-1A-14-1N after an invocable function 18-1A-18-1C has caused a change in state of a particular qubit 14-1A-14-1N.

The observation service 22, after the invocable function 18-1C has caused the desired change in state of the qubit 14-1A, observes a current state of the qubit 14-1A and stores the current state in the new qubit state 72. [Leigh, can we give a mechanism for observing a state of a qubit?] The observation service 22 compares the new qubit state 72 to the state identified in the previous qubit state 70. If the new qubit state 72 is different from the previous qubit state 70, the observation service 22 quantifies the difference in the delta qubit state 74. In this example, the observation service 22 indicates a pi/2 rotation about the X-axis. The observation service 22 then copies the new qubit state 72 to the previous qubit state 70 for subsequent qubit state change determinations.

The quantum computing system 12-1 then communicates a message to the classical computing system 20 that identifies the change in state of the qubit 14-1A. The message may include, for example, the user ID received in the request 66. In some examples, the message may be returned via the invocable function 18-1C to the classical rotation service 38. In other examples, the RBAC system 30 or the classical rotation service 38 implements a callback function for the quantum computing system 12-1 by which the quantum rotation service 16 can notify the classical computing system 20 of the change in the state of the qubit 14-1A.

The RBAC system 30 receives the message and determines that the change in state of the qubit 14-1A matches the qubit state change 56 identified in the access policy 48, and then grants the computing device 44 access to the file 36.

The quantum computing system 12-Z is configured similarly to the quantum computing system 12-1 and operates similarly on a different set of qubits 14-ZA-14-ZX.

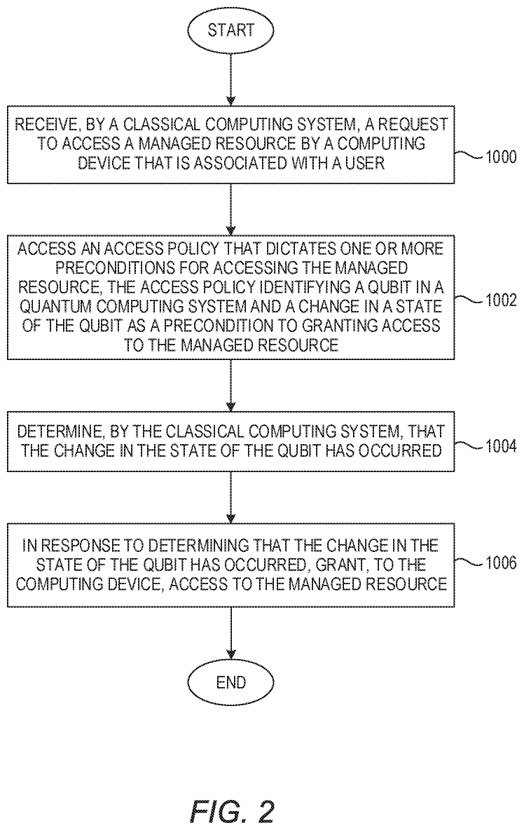

FIG. 2 is a flowchart of a method for authentication based on a change of a state of a qubit according to one example. FIG. 2 will be discussed in conjunction with FIG. 1. The classical computing system 20 receives the request 65 to access the managed resource 32-1 by the computing device 44 that is associated with the user 42 (FIG. 2, block 1000). The classical computing system 20 accesses the access policy 48 that dictates one or more preconditions for accessing the managed resource 32-1, the access policy 48 identifying the qubit 14-1 in the quantum computing system 12-1 and a change in the state of the qubit 14-1 as a precondition to granting access to the managed resource 32-1 (FIG. 2, block 1002). The classical computing system 20 determines that the change in the state of the qubit 14-1 has occurred (FIG. 2, block 1004), and in response to determining that the change in the state of the qubit 14-1 has occurred, the classical computing system 20 grants, to the computing device 44, access to the managed resource 32-1 (FIG. 2, block 1006).

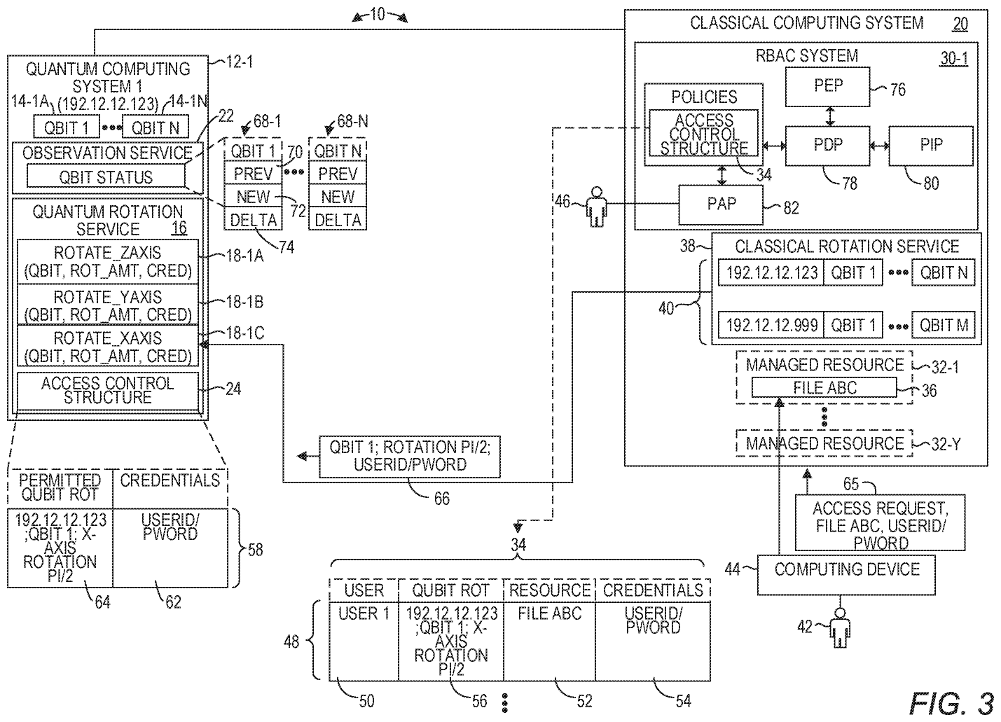

FIG. 3 is a block diagram of the environment 10 that illustrates a detailed implementation of an RBAC system 30-1 according to one example. In this example, the RBAC system 30-1 includes a policy enforcement point (PEP) 76, a policy decision point (PDP) 78, a policy information point (PIP) 80 and a policy access point (PAP) 82. The operator 46 interacts with the PAP 82 to maintain and modify the access control structure 34. The PEP 76 receives the request 65 to access the file 36. The PEP 76 may parse the request 65 into one or more structured parameters and values expected by other components of the RBAC system 30-1. The PEP 76 passes the information derived from the request 65 to the PDP 78. The PDP 78 accesses the access policy 48 in the access control structure 34 and determines that the credentials associated with the request 65 are correct based on the authentication credentials 54. The PDP 78 determines, based on the qubit state change 56, that there is an additional precondition prior to granting the computing device 44 access to the file 36, in particular, that the qubit 14-1A of the quantum computing system 12-1 must have a pi/2 rotation about the X-axis. The PDP 78 communicates this additional requirement to the PIP 80. The PIP 80 sends a request to the classical rotation service 38 to implement the necessary qubit state change. The classical rotation service 38 and the quantum computing system 12-1 then operate substantially in accordance as described above with regard to FIG. 1. The quantum rotation service 16 informs the classical rotation service 38 of the change in the state of the qubit 14-1A. The classical rotation service 38 informs the PIP 80 that the qubit 14-1A has been rotated pi/2 about the X-axis. The PIP 80 informs the PDP 78 that the qubit state change 56 has occurred. The PDP 78 determines that both preconditions have been met and informs the PEP 76 that access to the file 36 can be granted. The PEP 76 grants to the computing device 44 access to the file 36.

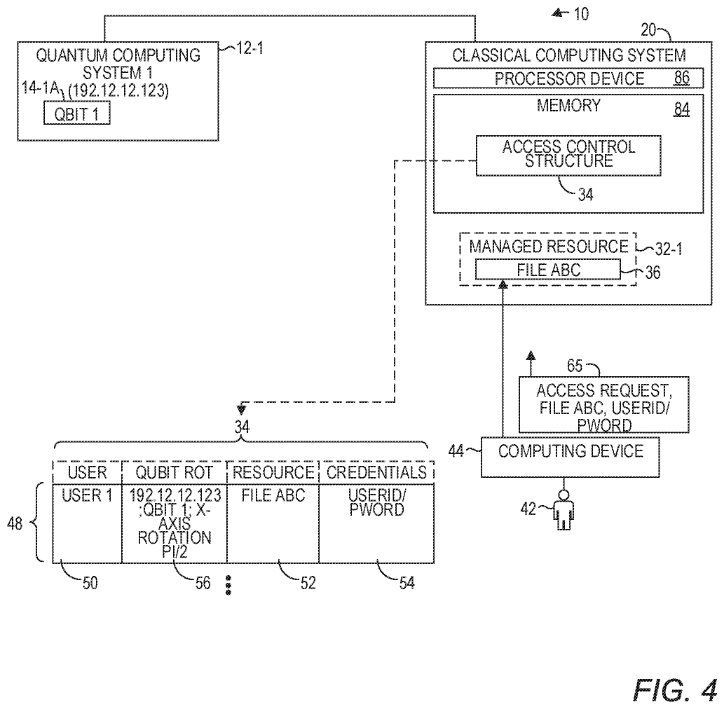

FIG. 4 is a simplified block diagram of the environment 10 according to another example. The classical computing system 20 includes a memory 84 and a processor device 86 coupled to the memory 84. The processor device 86 is to receive the request 65 to access the managed resource 32-1 by the computing device 44 that is associated with the user 42. The processor device 86 is further to access the access policy 48 that dictates the one or more preconditions for accessing the managed resource 32-1. The access policy 48 identifies the qubit 14-1A in the quantum computing system 12-1 and a change in the state of the qubit 14-1A as a precondition to granting access to the managed resource 32-1. The processor device 86 is further to determine that the change in the state of the qubit 14-1A has occurred and, in response to determining that the change in the state of the qubit 14-1A has occurred, to grant, to the computing device 44 access to the managed resource 32-1.

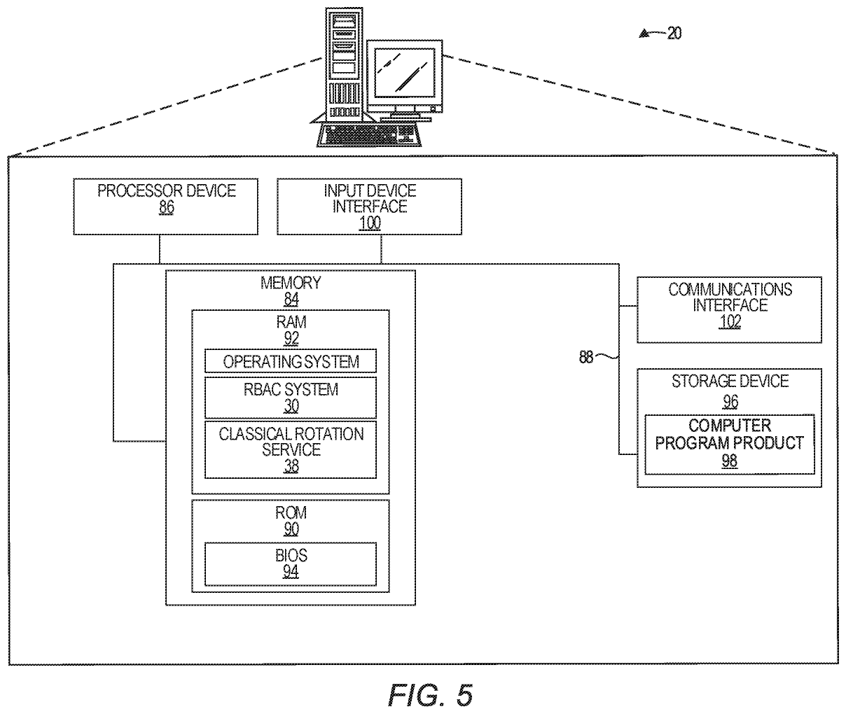

FIG. 5 is a block diagram of the classical computing system 20 suitable for implementing examples according to one example. The classical computing system 20 may comprise any computing or electronic device capable of including firmware, hardware, and/or executing software instructions to implement the functionality described herein, such as a computer server, a desktop computing device, a laptop computing device, a smartphone, a computing tablet, or the like. The classical computing system 20 includes the processor device 86, the memory 84, and a system bus 88. The system bus 88 provides an interface for system components including, but not limited to, the memory 84 and the processor device 86. The processor device 86 can be any commercially available or proprietary processor.

The system bus 88 may be any of several types of bus structures that may further interconnect to a memory bus (with or without a memory controller), a peripheral bus, and/or a local bus using any of a variety of commercially available bus architectures. The memory 84 may include non-volatile memory 90 (e.g., read-only memory (ROM), erasable programmable read-only memory (EPROM), electrically erasable programmable read-only memory (EEPROM), etc.), and volatile memory 92 (e.g., random-access memory (RAM)). A basic input/output system (BIOS) 94 may be stored in the non-volatile memory 90 and can include the basic routines that help to transfer information between elements within the classical computing system 20. The volatile memory 92 may also include a high-speed RAM, such as static RAM, for caching data.

The classical computing system 20 may further include or be coupled to a non-transitory computer-readable storage medium such as a storage device 96, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 96 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules can be stored in the storage device 96 and in the volatile memory 92, including an operating system and one or more program modules, such as the RBAC system 30 and classical rotation service 38, which may implement the functionality described herein in whole or in part.

All or a portion of the examples may be implemented as a computer program product 98 stored on a transitory or non-transitory computer-usable or computer-readable storage medium, such as the storage device 96, which includes complex programming instructions, such as complex computer-readable program code, to cause the processor device 86 to carry out the steps described herein. Thus, the computer-readable program code can comprise software instructions for implementing the functionality of the examples described herein when executed on the processor device 86. The processor device 86, in conjunction with the RBAC system 30 and classical rotation service 38 in the volatile memory 92, may serve as a controller, or control system, for the classical computing system 20 that is to implement the functionality described herein.

The operator 46 may also be able to enter one or more configuration commands through a keyboard (not illustrated), a pointing device such as a mouse (not illustrated), or a touch-sensitive surface. Such input devices may be connected to the processor device 86 through an input device interface 100 that is coupled to the system bus 88 but can be connected by other interfaces such as a parallel port, an Institute of Electrical and Electronic Engineers (IEEE) 1394 serial port, a Universal Serial Bus (USB) port, an IR interface, and the like.

The classical computing system 20 may also include a communications interface 102 suitable for communicating with other devices, such as the quantum computing systems 12-1-12-Z, as appropriate or desired.

Individuals will recognize improvements and modifications to the preferred examples of the disclosure. All such improvements and modifications are considered within the scope of the concepts disclosed herein and the claims that follow.

What is claimed is:

1. A method comprising:
receiving, by a classical computing system, a request to access a managed resource by a computing device that is associated with a user;
accessing an access policy that dictates one or more preconditions for accessing the managed resource, the access policy identifying a qubit in a quantum computing system and a change in a state of the qubit as a precondition to granting access to the managed resource;
determining, by the classical computing system, that the change in the state of the qubit has occurred; and
in response to determining that the change in the state of the qubit has occurred, granting, to the computing device, access to the managed resource.

2. The method of claim 1 further comprising sending, by the classical computing system to the quantum computing system, a request that the quantum computing system change the state of the qubit.

3. The method of claim 2 further comprising:
obtaining authentication credentials of the user; and
wherein the request to the quantum computing system that the quantum computing system change the state of the qubit includes the authentication credentials of the user.

4. The method of claim 2 further comprising:
receiving, by the quantum computing system, the request that the quantum computing system change the state of the qubit;
obtaining authentication credentials associated with the request;
validating the authentication credentials; and
in response to validating the authentication credentials, causing the change in the state of the qubit.

5. The method of claim 2 wherein sending, by the classical computing system to the quantum computing system, the request that the quantum computing system change the state of the qubit further comprises invoking, by the classical computing system, a function of the quantum computing system that is configured to cause a change of state of the qubit.

6. The method of claim 1 further comprising:
determining, by the quantum computing system, a state of the qubit at a first point in time;
determining a state of the qubit at a second point in time;
determining that the state of the qubit at the second point in time differs from the state of the qubit at the first point in time; and
communicating to the classical computing system a message that identifies a change in the state of the qubit from the first point in time to the second point in time.

7. The method of claim 6 wherein determining, by the classical computing system, that the change in the state of the qubit has occurred further comprises:
receiving, by the classical computing system, the message that identifies the change in the state of the qubit from the first point in time to the second point in time; and
determining that the change in the state of the qubit from the first point in time to the second point in time is a same change in the state as the change in the state of the qubit as the precondition to granting access to the managed resource.

8. The method of claim 1 wherein the change in the state of the qubit comprises a rotation of the qubit about an axis.

9. The method of claim 1 wherein the change in the state of the qubit comprises a predetermined rotation of the qubit about a predetermined axis of a plurality of axes.

10. The method of claim 1 wherein the managed resource comprises a data file.

11. The method of claim 1 wherein determining that the change in the state of the qubit has occurred comprises receiving, from a quantum observation service, information that indicates the change in the state of the qubit has occurred.

12. The method of claim 1 wherein the access policy indicates that authentication credentials of the user are a precondition of the one or more preconditions for accessing the managed resource, and further comprising:
validating the authentication credentials of the user; and
in response to determining that the change in the state of the qubit has occurred and validating the authentication credentials of the user, granting, to the computing device, access to the managed resource.

13. A classical computing system, comprising:
a memory; and
a processor device coupled to the memory to:
receive a request to access a managed resource by a computing device that is associated with a user;
access an access policy that dictates one or more preconditions for accessing the managed resource, the access policy identifying a qubit in a quantum computing system and a change in a state of the qubit as a precondition to granting access to the managed resource;
determine that the change in the state of the qubit has occurred; and
in response to determining that the change in the state of the qubit has occurred, grant, to the computing device, access to the managed resource.

14. The classical computing system of claim 13 wherein the processor device is further to:
send to the quantum computing system a request that the quantum computing system change the state of the qubit.

15. The classical computing system of claim 14 wherein the processor device is further to:
obtain authentication credentials of the user; and
wherein the request to the quantum computing system that the quantum computing system change the state of the qubit includes the authentication credentials of the user.

16. The classical computing system of claim 13 wherein the change in the state of the qubit comprises a rotation of the qubit about an axis.

17. A computer program product stored on a non-transitory computer-readable storage medium and including instructions to cause a processor device to:
receive a request to access a managed resource by a computing device that is associated with a user;
access an access policy that dictates one or more preconditions for accessing the managed resource, the access policy identifying a qubit in a quantum computing system and a change in a state of the qubit as a precondition to granting access to the managed resource;
determine that the change in the state of the qubit has occurred; and
in response to determining that the change in the state of the qubit has occurred, grant, to the computing device, access to the managed resource.

18. The computer program product of claim 17 wherein the instructions further cause the processor device to send to the quantum computing system a request that the quantum computing system change the state of the qubit.

19. The computer program product of claim 18 wherein the instructions further cause the processor device to:
obtain authentication credentials of the user; and
wherein the request to the quantum computing system that the quantum computing system change the state of the qubit includes the authentication credentials of the user.

20. The computer program product of claim 17 wherein the change in the state of the qubit comprises a rotation of the qubit about an axis.
